(19) United States
(12) Patent Application Publication
(10) Pub. No.: US 2009/0245636 A1
(43) Pub. Date: Oct. 1, 2009

(54) SYSTEM AND METHOD FOR BRIGHTNESS ADJUSTMENT FOR ELECTRONIC IMAGES

(76) Inventors: Jonathan Yen, San Jose, CA (US); William C. Kress, Vista, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/057,119

(22) Filed: Mar. 27, 2008

(51) Int. Cl. G06K 9/00

(52) U.S. Cl. 382/172

(57) ABSTRACT

The subject application is directed to a system and method for brightness adjustment of electronic images. Image data including a plurality of pixels is first received, with each pixel having an associated image value. Histogram data corresponding to a histogram of at least one component value corresponding to each of the pixels is then calculated. An image correction value is then calculated according to at least one characteristic of the calculated histogram data. A determination is then made regarding the application of the calculated image correction value from the calculated histogram data. Corrected image data is thereafter generated based upon the application of the calculated image correction value to each pixel.

### BACKGROUND OF THE INVENTION

The subject application is directed generally to enhancement or correction of electronic images. The application is particularly applicable to automated correction of white balance in connection with grayscale or color images.

Electronic images are captured from many devices, such as digital still cameras or digital movie cameras. Given the varied circumstances associated with a capture, image quality varies greatly. Variations may be induced by capabilities of imaging hardware, lighting conditions of a scene, or skill of an operator. By way of example, some cameras may have automatic aperture controls or may employ lighting or filter systems. Some images may be captured in less than optimal lighting conditions. Users may not be sufficiently sophisticated to use their equipment or position their target relative to lighting in such a way as to avoid problems. Any or all of these factors may lead to captured images with less than optimal characteristics for viewing or reproduction. Frequently, imaging problems are associated with brightness of a captured image.

Electronic images may be overly bright, too dark, or have one portion that is sufficiently bright so as to compromise the image as a whole. As an example of the latter situation, a light source may be directly in line with a camera, or a reflective surface may reflect too much light from a source disposed behind a photographer.

Software applications, such as Adobe Photoshop, include a mechanism by which a user can manually and subjectively alter brightness characteristics of a captured image.

### SUMMARY OF THE INVENTION

In accordance with one embodiment of the subject application, there is provided a system and method for enhancement or correction of electronic images.

Further in accordance with one embodiment of the subject application, there is provided a system and method for automated correction of white balance in connection with grayscale or color images.

Still further in accordance with one embodiment of the subject application, there is provided a system for brightness adjustment for electronic images. The system comprises means adapted for receiving image data inclusive of image values associated with each of a plurality of pixels and means adapted for calculating histogram data corresponding to a histogram of at least one component value corresponding to each of the plurality of pixels. The system also includes calculating means adapted for calculating an image correction value in accordance with at least one characteristic of calculated histogram data and determining means adapted for determining an application of the calculated image correction value from the calculated histogram data. The system further includes correction means adapted for generating corrected image data in accordance with a determined application of the calculated image correction value to each of the plurality of pixels.

In one embodiment of the subject application, each image value is defined within a selected image space such that each pixel is comprised of at least one component value, and wherein the system further includes means adapted for calculating the histogram data as a function of pixel component values.

In yet another embodiment of the subject application, the image space is multidimensional such that each pixel is comprised of a plurality of component values. In a further embodiment, the image space is defined as an RGB image space, and wherein each pixel includes a red component value, a green component value, and a blue component value.

In another embodiment of the subject application, the system also comprises testing means adapted for testing a functional relationship exhibited by the histogram data for a presence of a tail portion. In such embodiment, the calculating means includes means adapted for calculating the image correction value in accordance with a property of the tail portion. In a further embodiment, the calculating means includes means adapted for calculating the tail portion in accordance with a test against preselected threshold values. In yet a further embodiment, the property of the tail portion includes at least one of length and starting value thereof.

In a further embodiment of the subject application, the system also comprises detection means adapted for detecting at least one of the group consisting of a fog scene and a tinted artistic scene. In such an embodiment, the determining means further includes means for determining an application of the calculated image correction value in accordance with a detection of at least one of a fog scene and a tinted artistic scene.

Still further in accordance with one embodiment of the subject application, there is provided a method for brightness adjustment of electronic images in accordance with the system as set forth above.

Still other advantages, aspects, and features of the subject application will become readily apparent to those skilled in the art from the following description, wherein there is shown and described a preferred embodiment of the subject application, simply by way of illustration, of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject application is described with reference to certain figures, including:

FIG. 1 is an overall diagram of a system for brightness adjustment of electronic images according to one embodiment of the subject application;

FIG. 2 is a block diagram illustrating controller hardware for use in the system for brightness adjustment of electronic images according to one embodiment of the subject application;

FIG. 3 is a functional diagram illustrating the controller for use in the system for brightness adjustment of electronic images according to one embodiment of the subject application;

FIG. 4A is an example of an input image requiring image correction for use in the system for brightness adjustment of electronic images according to one embodiment of the subject application;

FIG. 4B is an example histogram of the input image of FIG. 4A for use in the system for brightness adjustment of electronic images according to one embodiment of the subject application;

FIG. 4C is an example of the input image of FIG. 4A after image correction according to one embodiment of the system for brightness adjustment of electronic images;

FIG. 4D is an example histogram of the corrected image of FIG. 4C for use in the system for brightness adjustment of electronic images according to one embodiment of the subject application;

FIG. 5A is another example of an input image requiring image correction for use in the system for brightness adjustment of electronic images according to one embodiment of the subject application;

FIG. 5B is an example histogram of the input image of FIG. 5A for use in the system for brightness adjustment of electronic images according to one embodiment of the subject application;

FIG. 6A is an example of the input image of FIG. 5A after image correction according to one embodiment of the system for brightness adjustment of electronic images;

FIG. 6B is an example histogram of the corrected image of FIG. 6A for use in the system for brightness adjustment of electronic images according to one embodiment of the subject application;

FIG. 7 is a close-up view of the histogram of FIG. 6B for use in the system for brightness adjustment of electronic images according to one embodiment of the subject application;

FIG. 8A is another example of an input image requiring image correction for use in the system for brightness adjustment of electronic images according to one embodiment of the subject application;

FIG. 8B is an example histogram of the input image of FIG. 8A for use in the system for brightness adjustment of electronic images according to one embodiment of the subject application;

FIG. 9 is a close-up view of the histogram of FIG. 8B for use in the system for brightness adjustment of electronic images according to one embodiment of the subject application;

FIG. 10A is yet another example of an input image requiring image correction for use in the system for brightness adjustment of electronic images according to one embodiment of the subject application;

FIG. 10B is an example histogram of the input image of FIG. 10A for use in the system for brightness adjustment of electronic images according to one embodiment of the subject application;

FIG. 11 is a close-up view of the histogram of FIG. 10B for use in the system for brightness adjustment of electronic images according to one embodiment of the subject application;

FIG. 12 is a close-up view of the histogram of FIG. 10B after forward differencing for use in the system for brightness adjustment of electronic images according to one embodiment of the subject application;

FIG. 13 is a close-up view of the histogram of FIG. 10B after convolution prior to forward differencing for use in the system for brightness adjustment of electronic images according to one embodiment of the subject application;

FIG. 14 is a close-up view of the histogram of FIG. 10B after forward differencing and convolution for use in the system for brightness adjustment of electronic images according to one embodiment of the subject application;

FIG. 15 is a detailed view of the histogram of FIG. 14 after forward differencing and convolution for use in the system for brightness adjustment of electronic images according to one embodiment of the subject application;

FIG. 16 is a plot illustrating tail length with respect to the amount of image correction recorded in ground truth for the system for brightness adjustment of electronic images according to one embodiment of the subject application;

FIG. 17A is an illustration depicting a correlation between tail length and amount of image correction in ground truth for the system for brightness adjustment of electronic images according to one embodiment of the subject application;

FIG. 17B is an illustration depicting a correlation between tail length and amount of image correction in ground truth for the system for brightness adjustment of electronic images according to one embodiment of the subject application;

FIG. 18A is an example of the input image of 10A, requiring image correction, for use in the system for brightness adjustment of electronic images according to one embodiment of the subject application;

FIG. 18B is an example of the input image of FIG. 18A after image correction according to one embodiment of the system for brightness adjustment of electronic images;

FIG. 19 is a histogram corresponding to a potential false-positive input image, corresponding to image correction, for use in the system for brightness adjustment of electronic images according to one embodiment of the subject application;

FIG. 20 is a histogram corresponding to an additional potential false-positive input image, corresponding to image correction, for use in the system for brightness adjustment of electronic images according to one embodiment of the subject application;

FIG. 21 is a histogram corresponding to a potential false-positive input image, corresponding to image correction, for use in the system for brightness adjustment of electronic images according to one embodiment of the subject application;

FIG. 22 is another histogram corresponding to a potential false-positive input image, corresponding to image correction, for use in the system for brightness adjustment of electronic images according to one embodiment of the subject application;

FIG. 23 is a flowchart illustrating a method for brightness adjustment of electronic images according to one embodiment of the subject application; and

FIG. 24 is a flowchart illustrating a method for brightness adjustment of electronic images according to one embodiment of the subject application.

### DETAILED DESCRIPTION OF THE PREFERRED EMBODIMENT

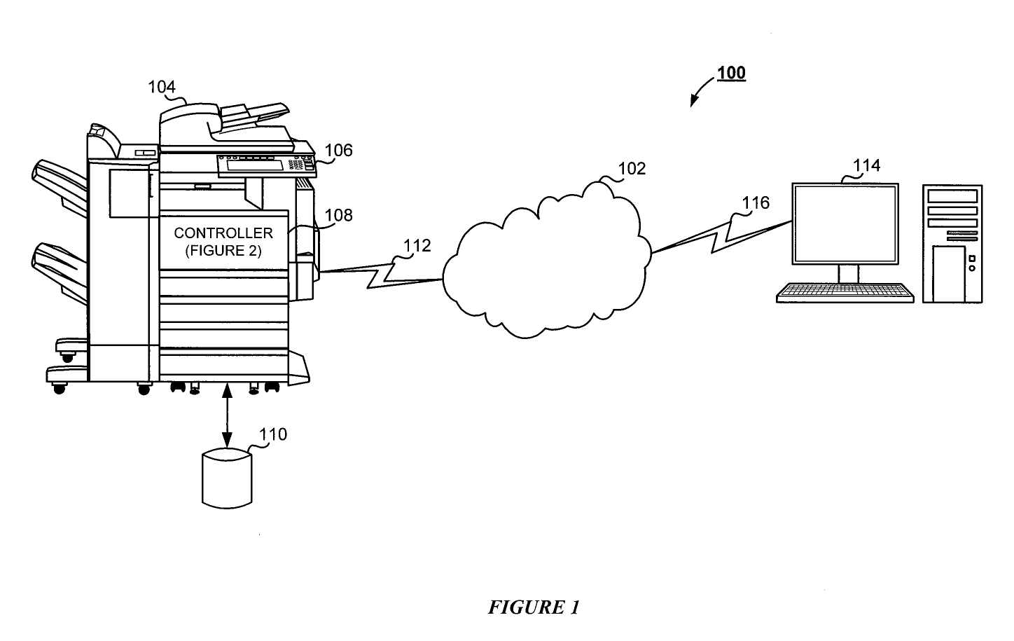

The subject application is directed to a system and method for enhancement or correction of electronic images. In particular, the subject application is directed to a system and method for automated correction of white balance in connection with grayscale or color images. More particularly, the subject application is directed to a system and method for brightness adjustment for electronic images. It will become apparent to those skilled in the art that the system and method described herein are suitably adapted to a plurality of varying electronic fields employing automated adjustments including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for brightness adjustment for electronic images in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms, such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof configured to interact with an associated user, a networked device, or the like.

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

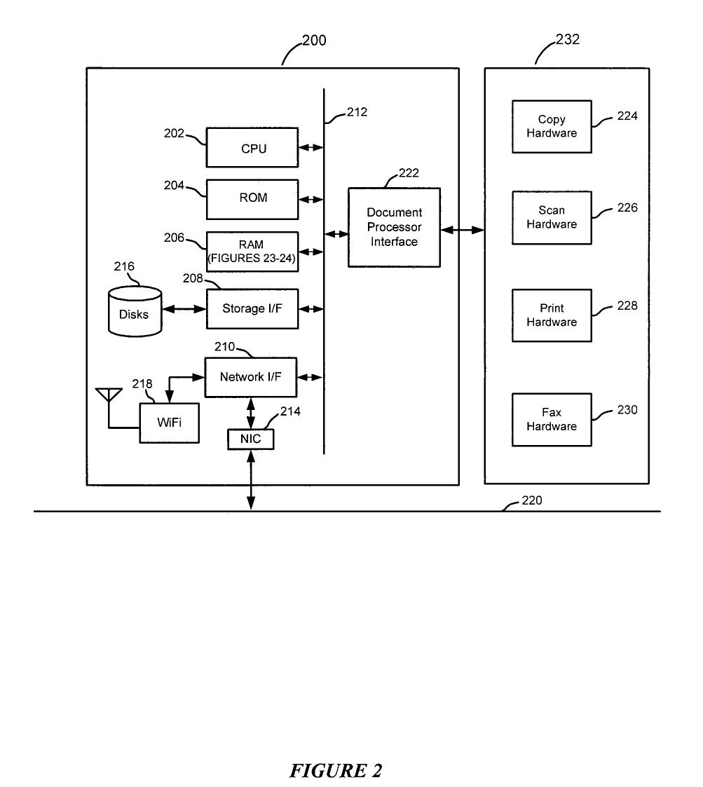

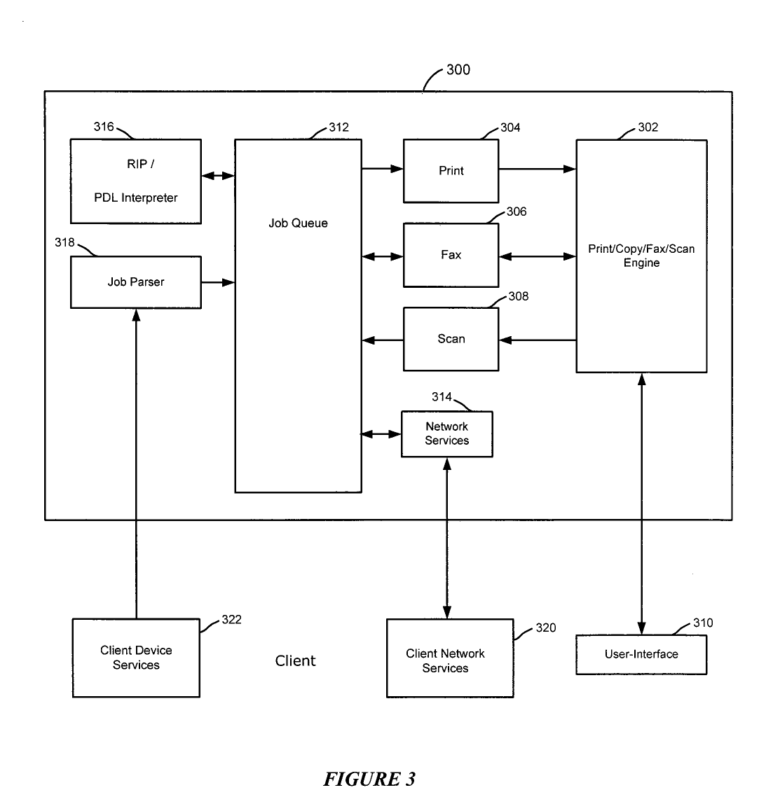

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, facilitate the display of images via the user interface 106, direct the manipulation of electronic image data, and the like. For purposes of explanation, the controller 108 is used to refer to any of the myriad components associated with the document processing device 104, including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art and, thus, the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for brightness adjustment for electronic images of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive or the like.

The system 100 illustrated in FIG. 1 further depicts a user device 114 in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including but not limited to wireless communications; for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 114 is suitably adapted to generate and transmit electronic documents, document processing instructions, user interface modifications, upgrades, updates, personalization data, or the like to the document processing device 104 or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device known in the art that is capable of facilitating the methodologies described herein. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the controller 200.

Also included in the controller 200 is random access memory 206 suitably formed of dynamic random access memory; static random access memory; or any other suitable, addressable, and writable memory system. Random access memory 206 provides a storage area for data instructions associated with applications and data handling accomplished by the processor 202.

A storage interface 208 suitably provides a mechanism for non-volatile, bulk, or long term storage of data associated with the controller 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the controller 200 to communicate to other devices. The network interface subsystem 210 suitably interfaces with one or more connections with external devices to the device 200. By way of example, illustrated is at least one network interface card 214 for data communication with fixed or wired networks such as Ethernet, token ring, and the like, and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2 (shown in FIG. 1 as the controller 108) as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality, as will be appreciated by one of ordinary skill in the art.

In the preferred embodiment, the engine 302 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more-limited purpose document processing devices capable of performing only one or more of the document processing operations listed above.

The engine 302 is suitably interfaced to a user interface panel 310, which panel 310 allows for a user or administrator to access functionality controlled by the engine 302. Access is suitably enabled via an interface local to the controller or remotely via a remote thin or thick client.

The engine 302 is in data communication with print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network-based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306, or scan 308.

Finally, the job queue 312 is in data communication with a job parser 318, which job parser 318 suitably functions to receive print job language files from an external device, such as client device services 322. The client device services 322 suitably include printing, facsimile transmission, or other suitable input of an electronic document for which handling by the controller function 300 is advantageous. The job parser 318 functions to interpret a received electronic document file and relay it to the job queue 312 for handling in connection with the afore-described functionality and components.

In operation, image data is received, including an image value associated with each of a plurality of pixels. Histogram data is then calculated corresponding to a histogram of at least one component value corresponding to each pixel. An image correction value is then calculated in accordance with at least one characteristic of the calculated histogram data. An application of the calculated image correction value is then determined from the calculated histogram data. Corrected image data is then generated in accordance with the determined application of the calculated image correction value to each of the plurality of pixels.

In accordance with one example embodiment of the subject application, an electronic image is received by the controller 108 or other suitable component associated with the document processing device 104, the user device 114, or the like. Preferably, the image data includes image values associated with each of the pixels comprising the image. According to one embodiment of the subject application, each image value is defined within a selected image space, such that each pixel is comprised of at least one component value. A suitable image space includes a multidimensional space resulting in each pixel having a plurality of component values, e.g., Red-Green-Blue (RGB) image space, whereupon each pixel has a red component value, a green component value, and a blue component value.

The controller 108 or other suitable component associated with the document processing device 104, the user device 114, or other such component capable of processing electronic images then generates histogram data as a function of the pixel values. According to one embodiment of the subject application, an RGB histogram is calculated by the controller 108, the user device 114, or the like and is normalized by the total number of pixels, as will be understood by those skilled in the art. A first order forward difference and average convolutions are then applied to the histogram data. For example and without limitation, convolution is applied in a running average of P to smooth the normalized histogram and then calculate its M-th order forward difference. According to one embodiment of the subject application, suitable examples of parameters used herein include, without limitation, P=7 and M=1, as will be appreciated by those skilled in the art.

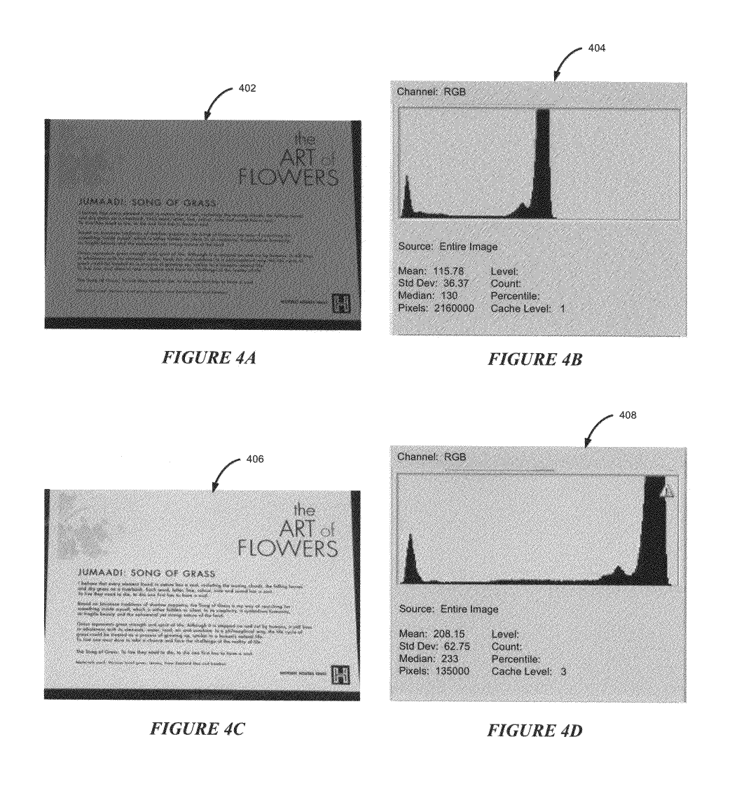

A functional relationship exhibited by the histogram is then tested for the presence of a tail portion. Suitable examples of such tail portions are further discussed below with respect to FIGS. 4A through 22. Based upon the testing, a determination is made as to whether a tail portion is present in the histogram data. When no tail portion in the histogram data is detected by the controller 108 or other suitable component associated with the document processing device 104, the user device 114, or the like, no image correction, e.g., global brightness enhancement, white stretch, or the like, is undertaken in accordance with the subject application.

Upon a determination that the results of the functional relationship testing of the histogram data indicates that a tail is present, the tail start and tail length are calculated. That is, the controller 108 or other suitable component associated with the document processing device 104, the user device 114, or the like then determines the point at which the tail portion begins on the histogram data and the length that such tail portion runs, as will be appreciated by those skilled in the art. The controller 108 or other suitable component associated with the document processing device 104 then determines whether the tail starts sufficiently early; that is, whether the start point of the tail portion occurs sufficiently early in the input image to prompt the application of brightness adjustment, e.g., white stretch, in accordance with the subject application. When the tail does not begin sufficiently early, no brightness adjustment in accordance with the system and method of the subject application is applied.

When the controller 108 or other suitable component associated with the document processing device 104 or the user device 114 determines that the tail does begin sufficiently early, e.g., starts at a predetermined point on the histogram, a determination is then made as to whether the length of the tail meets or exceeds a predetermined length, e.g., whether or not the tail portion is of sufficient length to implement brightness adjustment. When the length of the tail does not meet the predetermined threshold length, the brightness adjustment of the system and method of the subject application is not applied. In the event that the length of the tail meets or exceeds the predetermined threshold length, a determination is made as to whether the histogram count at the beginning of the tail is at or below a predetermined level. When the histogram count exceeds the predetermined level at the start of the tail portion, the brightness adjustment system and method of the subject application are not applied to the received image data. Upon a determination that the count at the start of the tail portion is at or below the predetermined level, an analysis is made of the received image data so as to determine whether the image is a fog scene or an artistically tinted scene. If either is true, no brightness adjustment is applied to the received image data.

Upon a determination that the received image data is not a fog or artistic tinted scene, an image correction value is calculated in accordance with a property of the tail portion. Thereafter, corrected image data, e.g., brightness adjusted image data, is generated in accordance with the application of the calculated image correction value to each of the pixels of the received image data.

The foregoing will be better understood in conjunction with the additional example implementations of the system and method of the subject application, depicted in FIGS. 4A through 22. FIG. 4A depicts an input image 402 representative of received image data requiring brightness adjustment in accordance with the subject application. An associated RGB histogram of the image 402 is shown at 404 in FIG. 4B. FIG. 4C depicts an image 406 corresponding to the image 402 of FIG. 4A following application of the system and method for brightness adjustment in accordance with the subject application. FIG. 4D, as will be appreciated by those skilled in the art, depicts the histogram 408 corresponding to the image 406 of FIG. 4C, representing post-brightness adjustment in accordance with the subject application.

Thus, the skilled artisan will appreciate that the brightness adjustment of the subject application corresponds to white stretching of the image, similar to holding the black end of the histogram and stretching the other end towards white in order to utilize the full dynamic range of the image. It will be understood by those skilled in the art that the white stretching or brightness adjustment of the subject application is equivalent to mapping the 8-bit code values from (0, N) to (0, 255) where N is a selected code value. The amount of white stretch, Delta, is determined by the selection of N.

It will be understood by those skilled in the art that images frequently have very small bright areas that are capable of being safely clipped without a corresponding decrease in image quality. For example, the small bright area is capable of corresponding to a specular highlight or a small white area in the image. In a histogram generated in accordance with received image data, the small bright areas result in a long tail possibly stretching all the way to the maximum code value, e.g., 255, 255, 255 in an 8-bit image.

The skilled artisan will appreciate that a long tail containing many pixels is capable of indicating that a white object is important and therefore should not be clipped, e.g., adjusted. In accordance with the subject application, as the number of pixels in the long tail diminishes, the more likely it is that clipping is capable of being accomplished without an associated decrease in image quality.

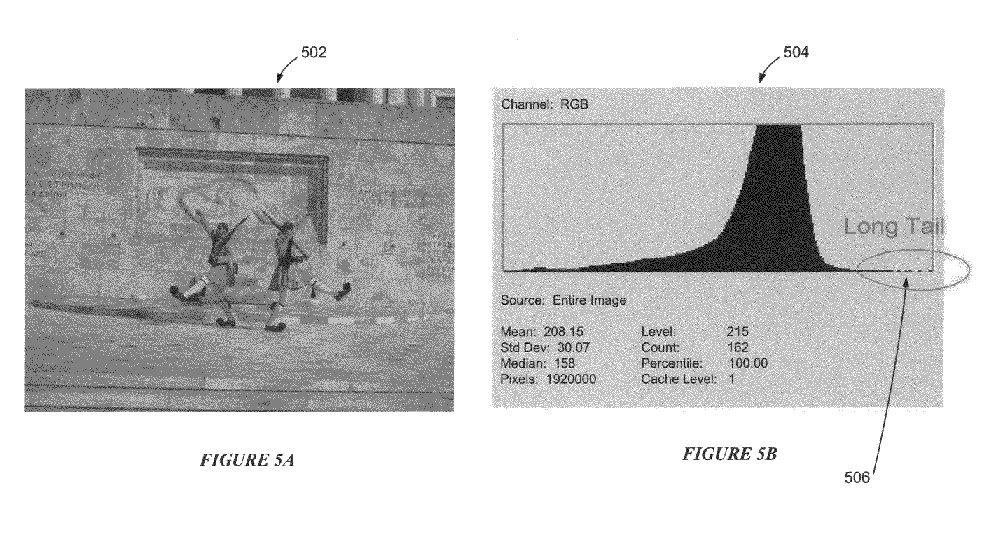

Turning now to FIG. 5A, there is shown received image data corresponding to an input image 502. A histogram 504, illustrated in FIG. 5B, is then generated by the controller 108 or other suitable component associated with the document processing device 104, the user device 114, or other similar computing device, so as to determine whether brightness adjustment, e.g., white stretching, is warranted. As shown in FIG. 5B, the histogram 504 includes a long tail 506 towards the white end of the histogram 504. As stated above, when a long tail 506 is detected, suitable brightness adjustment is then undertaken, absent the presence of fog scenes or artistic tint. The skilled artisan will appreciate that the input image 502 does not represent either a fog scene or an artistic tint scene, which therefore indicates that the brightness adjustment of the subject application is warranted.

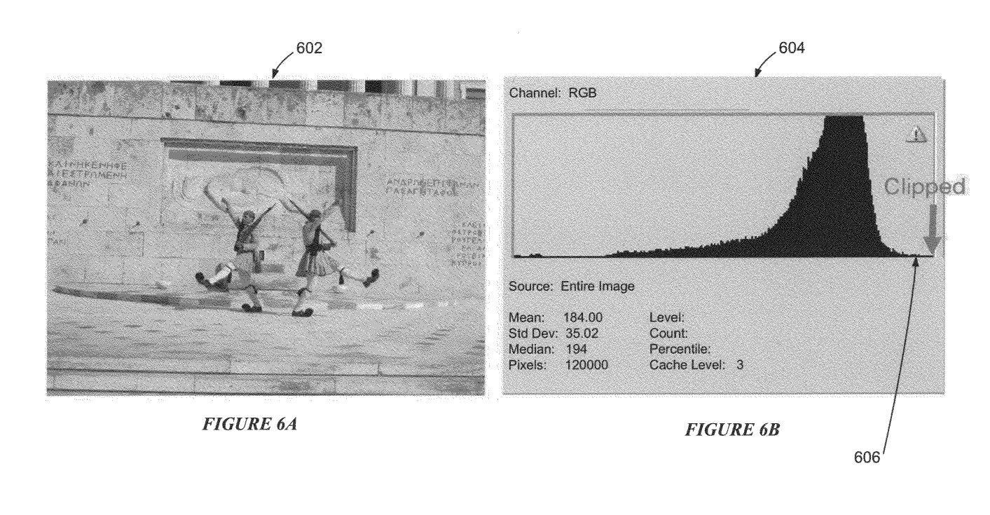

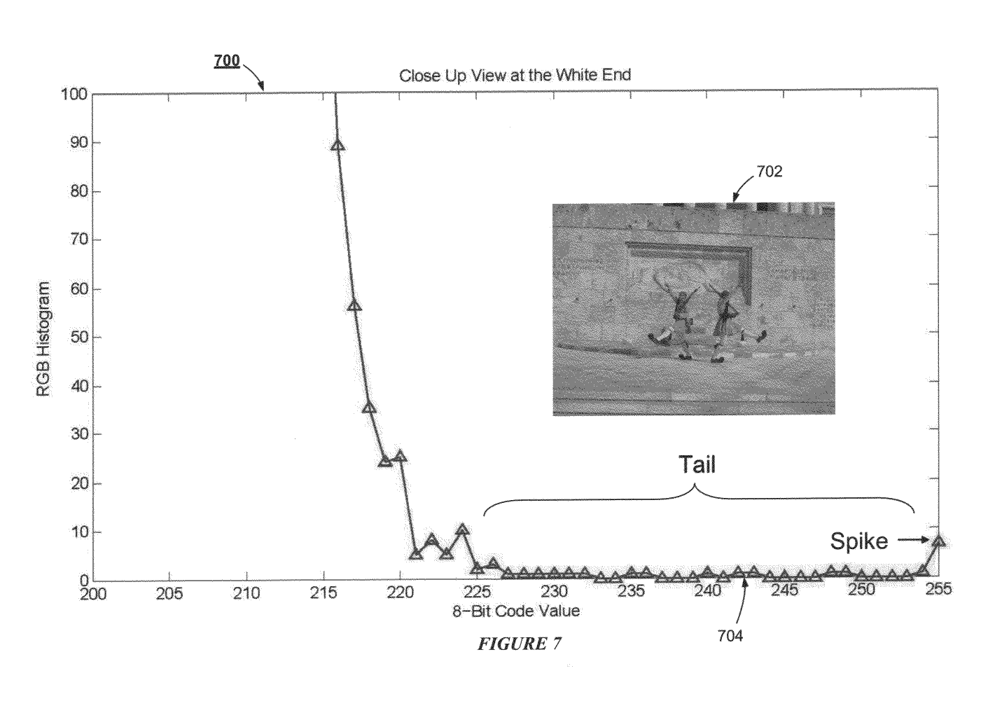

FIG. 6A illustrates an adjusted image 602, corresponding to the image 502 of FIG. 5A, after suitable brightness adjustment in accordance with one embodiment of the subject application. A histogram 604 of FIG. 6B corresponds to the adjusted image 602 of FIG. 6A, illustrating the clipped tail 606 after suitable application of the adjustment of the subject application. FIG. 7 includes a histogram 700 depicting a close up view of a long tail 704 of an image 702 corresponding to the received image 502 of FIG. 5A. As shown in FIG. 7, the histogram 700 diminishes towards the white end, with possibly a spike representing some white points in the image. Thus, the skilled artisan will appreciate that, in accordance with one embodiment of the subject application, the existence of such a characteristic phenomenon in RGB histogram of an image is detected.

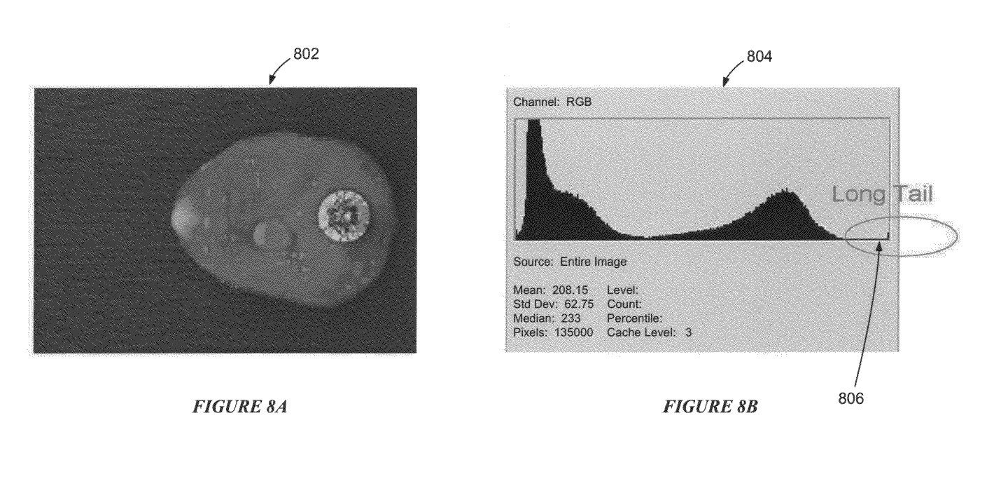

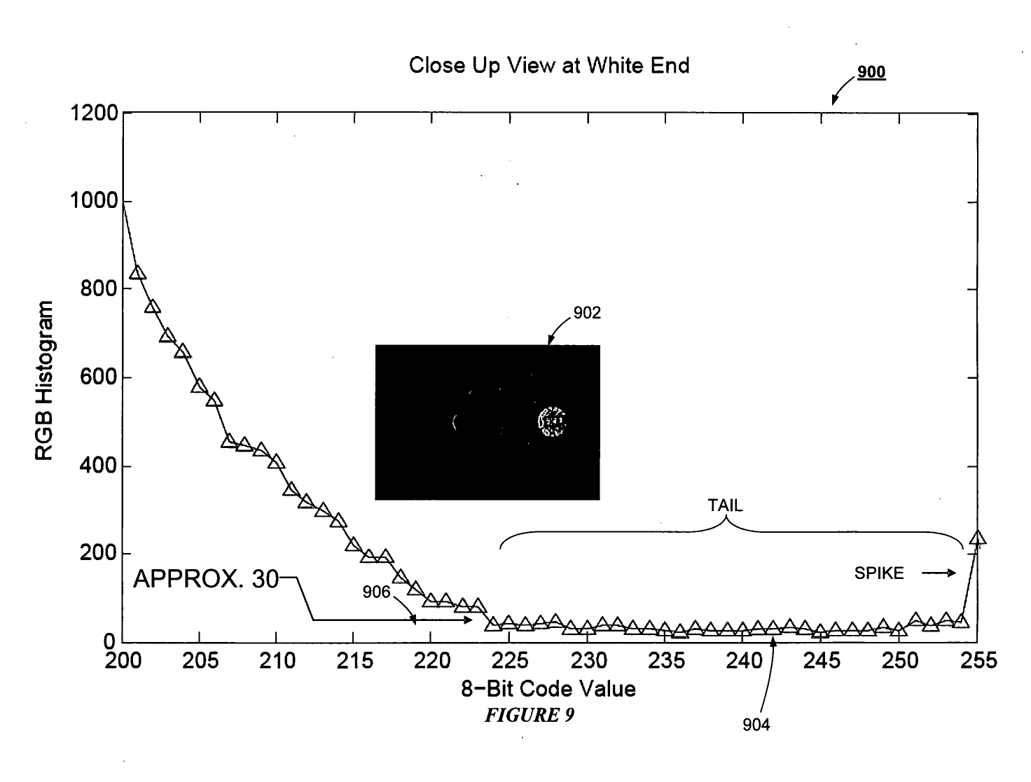

Turning now to FIGS. 8A and 8B, there is shown another example image 802 having a long tail 806 in a histogram 804 corresponding to the image 802. The skilled artisan will appreciate that FIG. 9 depicts a close-up view histogram 900 corresponding to an image 902 (802 in FIG. 8A) and the histogram 804 of FIG. 8B. A long tail 904 of the histogram 900 reveals, as will be appreciated by those skilled in the art, that the tail 904 does not always diminish completely to zero, floating at roughly 30, as illustrated in FIG. 9 at 906.

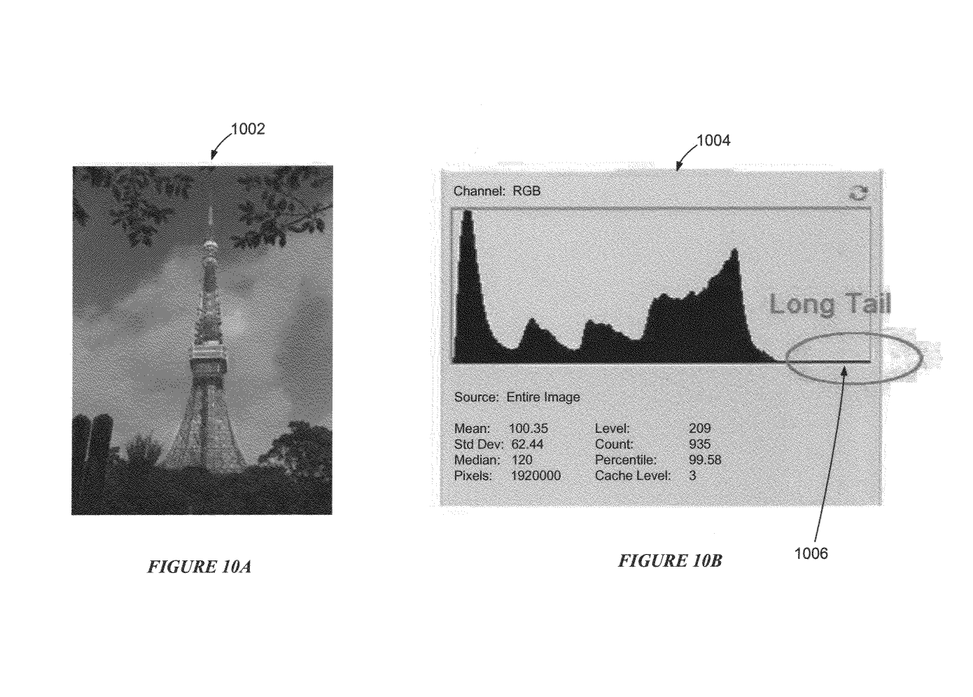

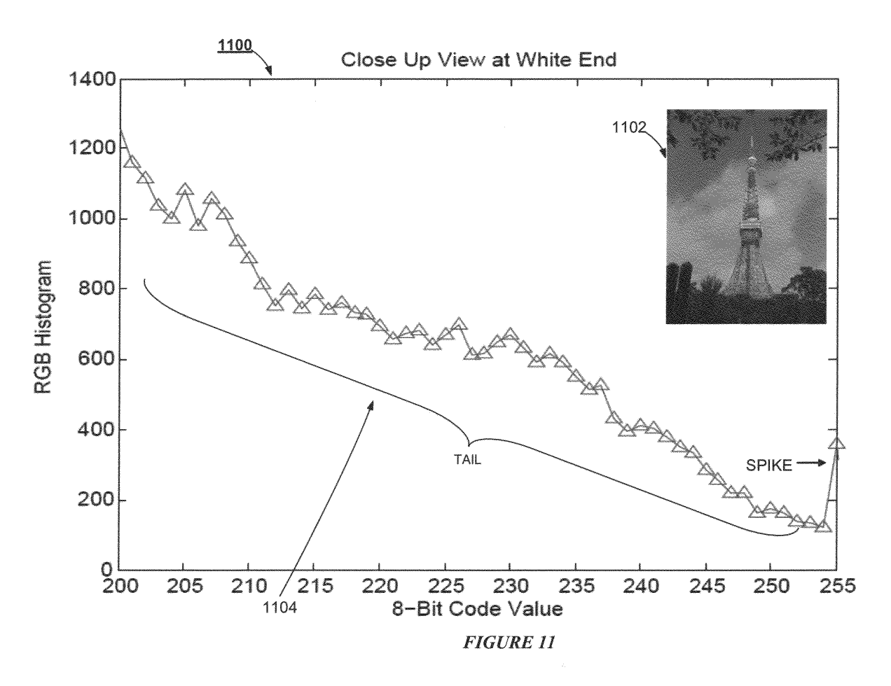

FIG. 10A and FIG. 10B illustrate another example input image 1002 and a corresponding histogram 1004 with a long tail 1006 to be analyzed in accordance with the system and method for brightness adjustment of electronic images in accordance with one embodiment of the subject application. FIG. 11 depicts a close-up view 1100 of the long tail 1006 of FIG. 10B, corresponding to the image 1102 (shown in FIG. 10A as the image 1002). As illustrated in FIG. 11, the long tail 1104 is not completely flat but, rather, continuously diminishes, as will be appreciated by those skilled in the art.

The skilled artisan will understand that forward differencing is capable of being applied to alleviate these problems, e.g., the failure of the tail to diminish completely to zero and the apparent lack of a relatively flat long tail. According to one embodiment of the subject application, application of a first order forward difference is sufficient to alleviate the aforementioned problems. Those skilled in the art will appreciate that, while first order differencing is used hereinafter, other orders, e.g., second and third orders, are also capable of being used for forward differencing in accordance with the subject application. For example, if H is the RGB histogram of bin size 1, H[i] is defined as the histogram count at the i-th code value, e.g., H[1] is the number of pixels in the image with value 0 in 8-bit code values and H[128] is the number of pixels in the image with value 127 in 8-bit code values, and so on. Application thereafter of the first order forward difference is thus D[i]=H[i]−H[i+1].

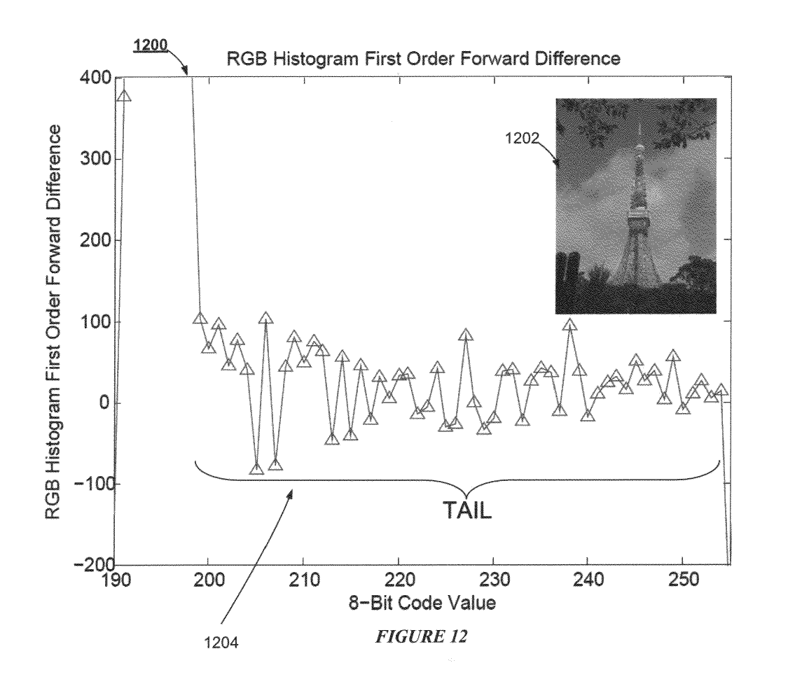

FIG. 12 depicts a close-up view of a histogram 1200 associated with an image 1202 (shown as the image 1002 in FIG. 10A) having a long tail 1204 after the application of the first order forward difference. It will be noted by those skilled in the art that small undulations are observable in the histogram first order forward difference 1200 of FIG. 12. In accordance with one particular embodiment of the subject application, convolutions by averaging are used to smooth out these undulations. Various running averages are capable of being used, as will be understood by those skilled in the art, including, for example and without limitation, running average of 5, 7 and 9. For example purposes only, reference is made hereinafter to averaging by 7, which, as will be apparent to those skilled in the art, provides a good tradeoff between the computational cost and the smoothing effect.

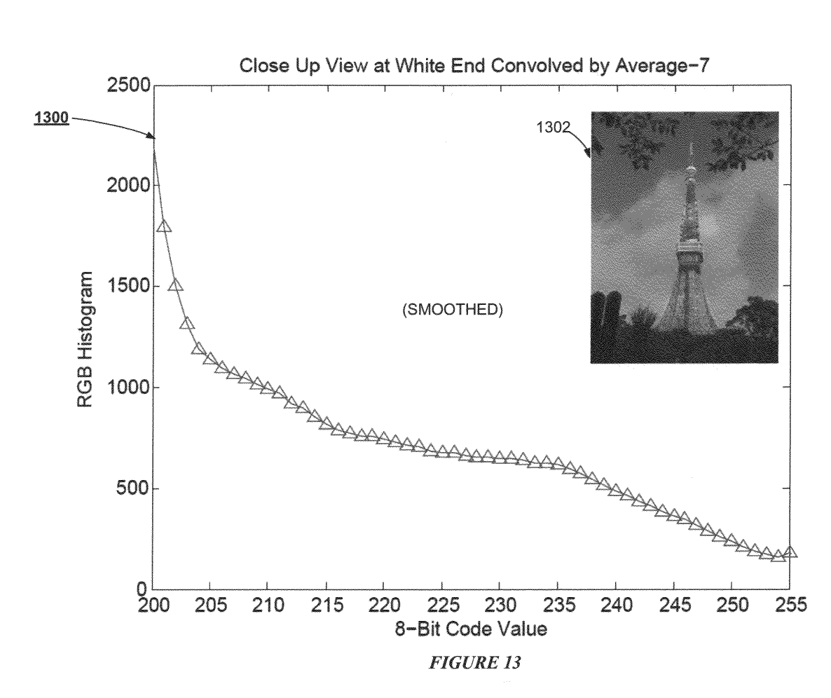

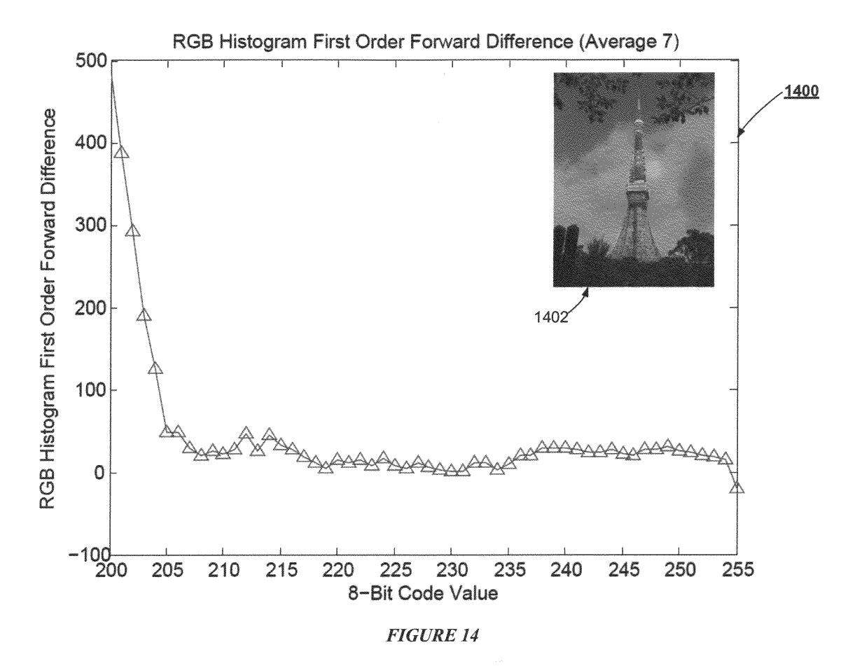

FIG. 13 illustrates the results of convolution by running average of 7 in a histogram 1300 corresponding to an image 1302 (image 1002 of FIG. 10A) prior to the application of the first order forward difference. A histogram 1400 is depicted in FIG. 14 illustrating the application of both the averaging and the differencing to an image 1402 (1002 in FIG. 10A) in accordance with the subject application.

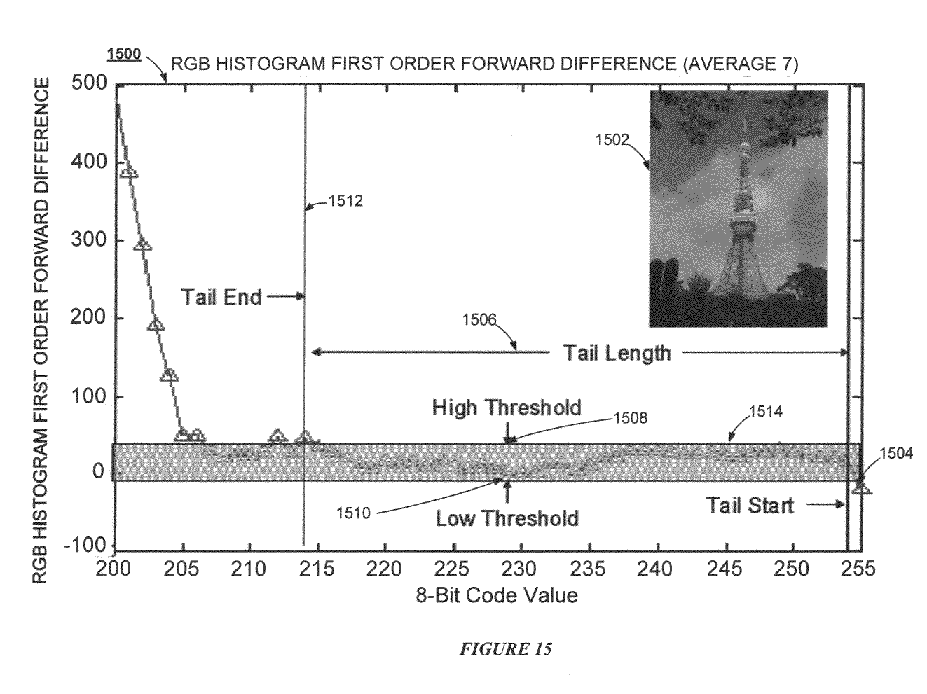

Turning now to FIG. 15, there is shown a detailed histogram 1500 of the image 1502 (shown in FIG. 10A as the image 1002) corresponding to the application of both the average (7) and the difference (first order) in accordance with the subject application. FIG. 15 also shows that a tail zone 1514 (shaded region) is defined by a high threshold value HT 1508 and a low threshold value LT 1510 such that traversing from code value 255 and downwards the histogram enters the tail zone at tail start 1504 (about 254) and leaves the tail zone at tail end 1512 (about 214) with tail length=tail start−tail end+1=41 (tail length 1506=tail start (1504)−tail end (1512)+1=41).

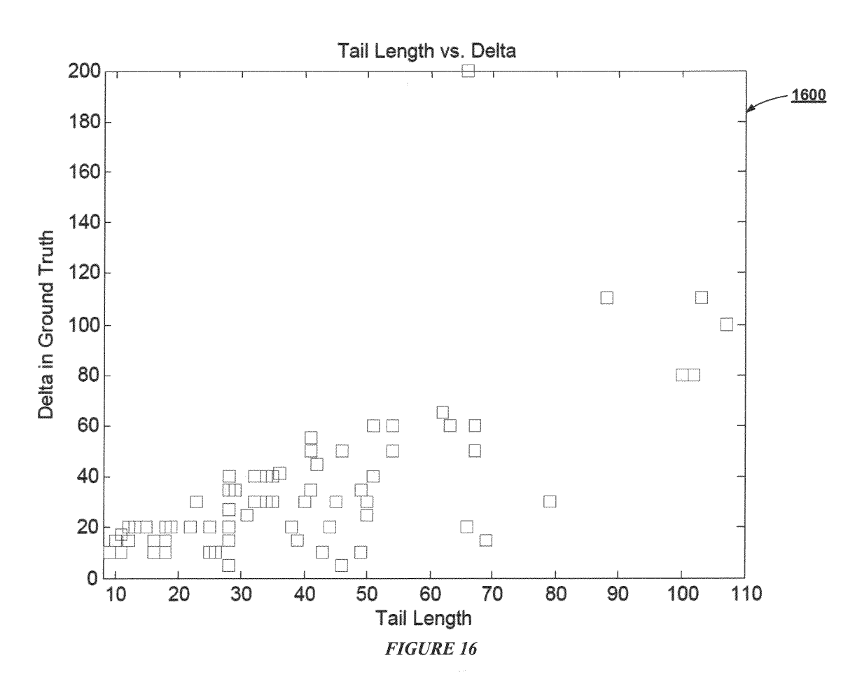

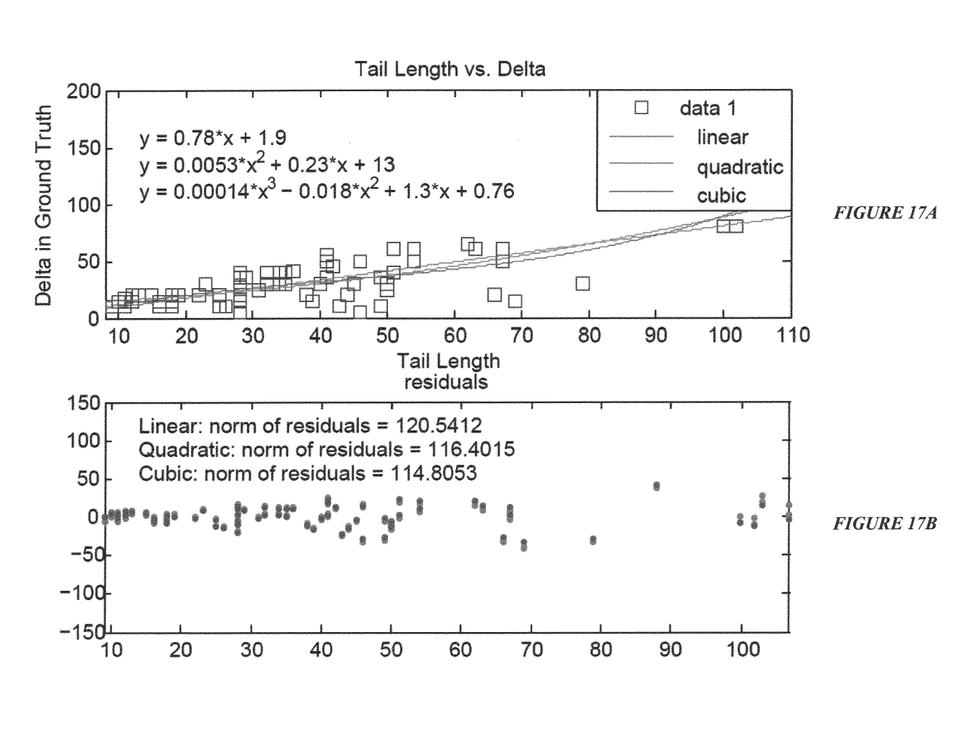

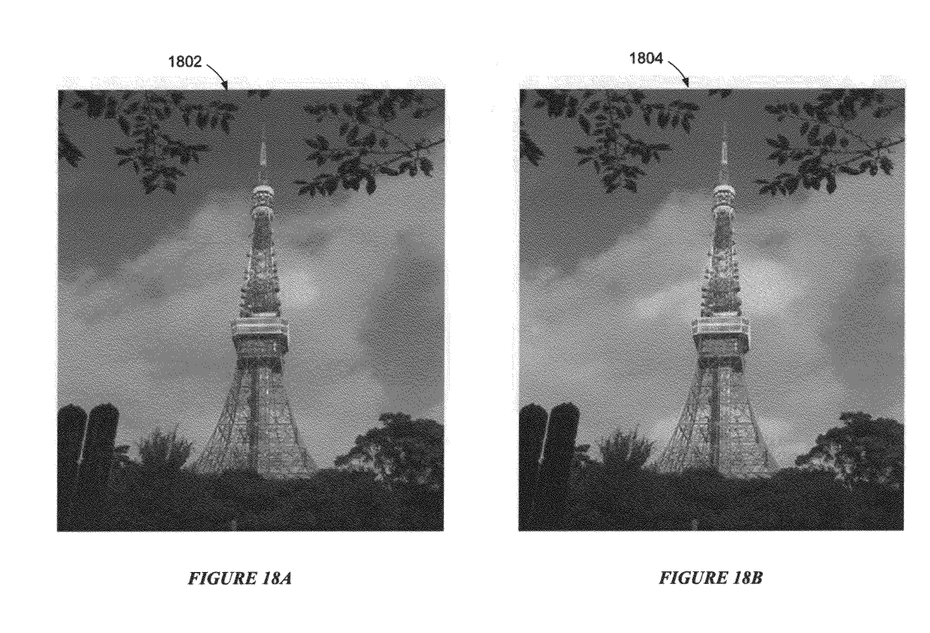

The skilled artisan will appreciate that the determination of a suitable ground truth, for use in the example embodiments described hereinafter, is capable of being accomplished via the means and methods known in the art. In accordance with one embodiment of the subject application, a sampling of 500 images with typical ontology specific to desired applications are capable of being selected, whereupon ground truth of these sample images is determined in accordance with judgments on the image quality, necessary adjustments to improve the image quality, amount of adjustments, and the like. The skilled artisan will thereafter appreciate that the determined ground truth is useful in identifying those images among a plurality of received images in need of the brightness adjustment in accordance with the subject application. Thus, the derivation of the HT 1508 and LT 1510 values, the tail start 1504, and tail end 1512 is accomplished by optimizing the rate on detecting the images in need of brightness adjustment, e.g., white stretching. FIG. 16 depicts a plot 1600 of the tail length 1506 (of FIG. 15) and the amount of brightness adjustment (white stretch) recorded in the ground truth. FIGS. 17A and 17B show the correlation between the two (the tail length 1506 and white stretch (brightness adjustment) in linear, quadratic, and cubic fitting functions and their norm of residuals). For example and without limitation, a suitable linear correlation comprises: amount of WS, Delta=0.78*Tail Length+1.9. Thus, as will be appreciated by those skilled in the art, FIG. 18A illustrates a received image 1802 and FIG. 18B illustrates an image 1804 after application of the brightness adjustment of the subject application.

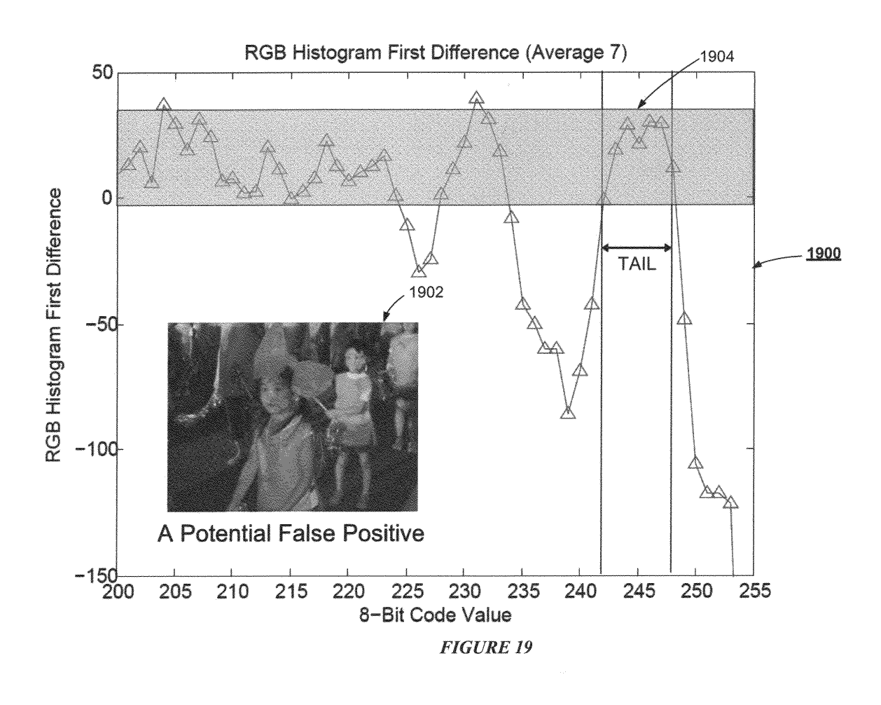

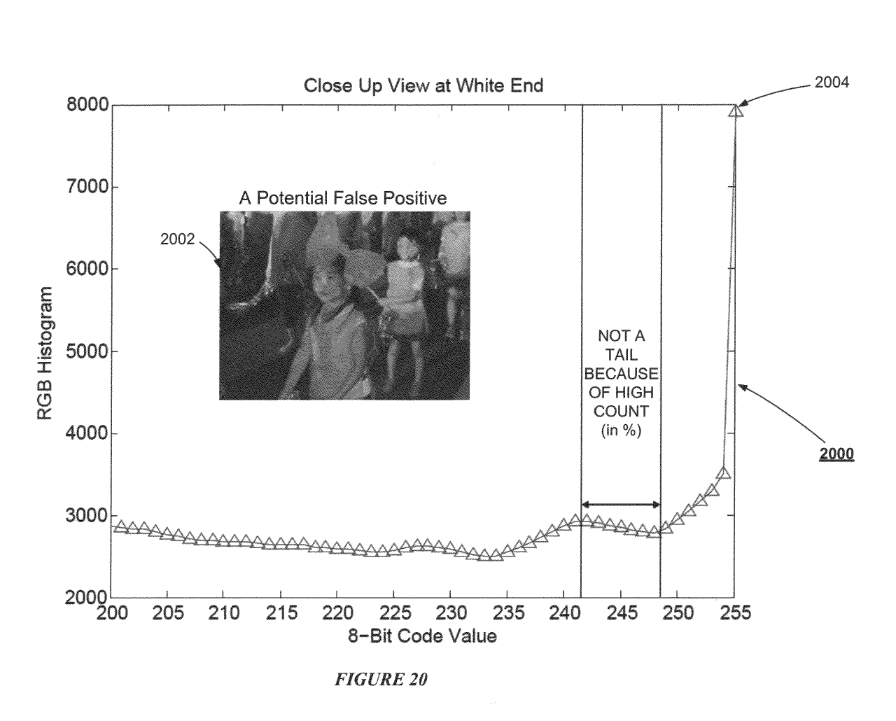

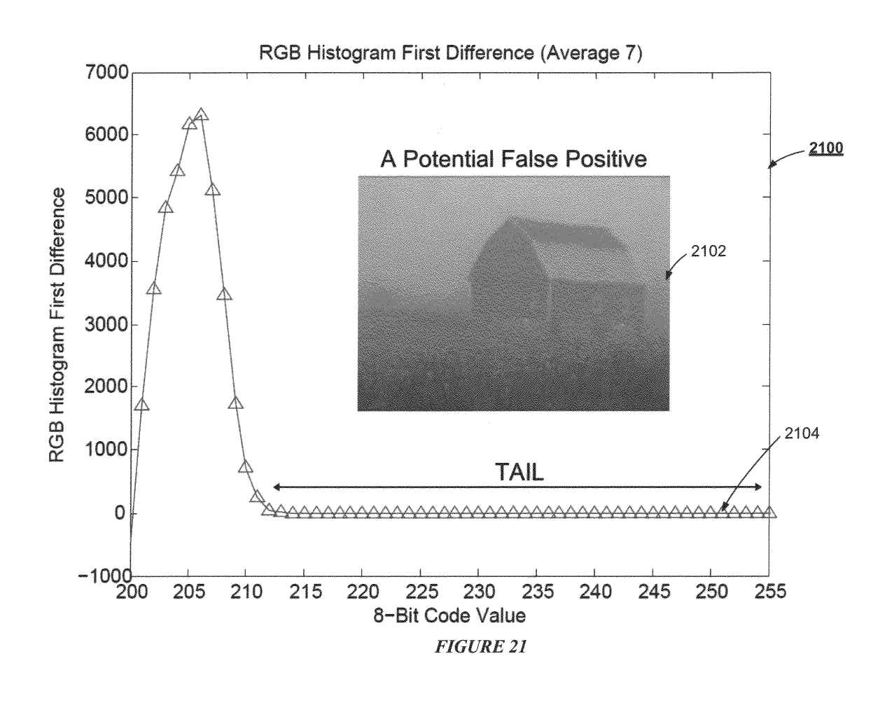

The skilled artisan will appreciate, however, that there are several conditions in which brightness adjustment or white stretch should not be applied. FIG. 19 shows an example histogram 1900 of a false positive image 1902 (false alarm): its forward difference of smoothed and normalized RGB histogram contains a legitimate long tail 1904, but brightness adjustment was not applied in the ground truth. FIG. 20 depicts a close-up view of the RGB histogram 2000 of the image 2002 (shown in FIG. 19 as the image 1902), illustrating that the histogram count is uncharacteristically high at tail start 2004. FIG. 21 shows another example histogram 2100 of a false positive image 2102: it contains a legitimate long tail 2104, but brightness adjustment was not applied in the ground truth because this is a partial fog scene, and brightness adjustment should not be applied to fog scenes and partial fog scenes. Suitable detection of fog scenes in received image data is explained in U.S. patent Application Ser. No. 11/851,160, entitled A SYSTEM AND METHOD FOR IMAGE FOG SCENE DETECTION, filed Sep. 6, 2007, the entirety of which is incorporated herein by reference.

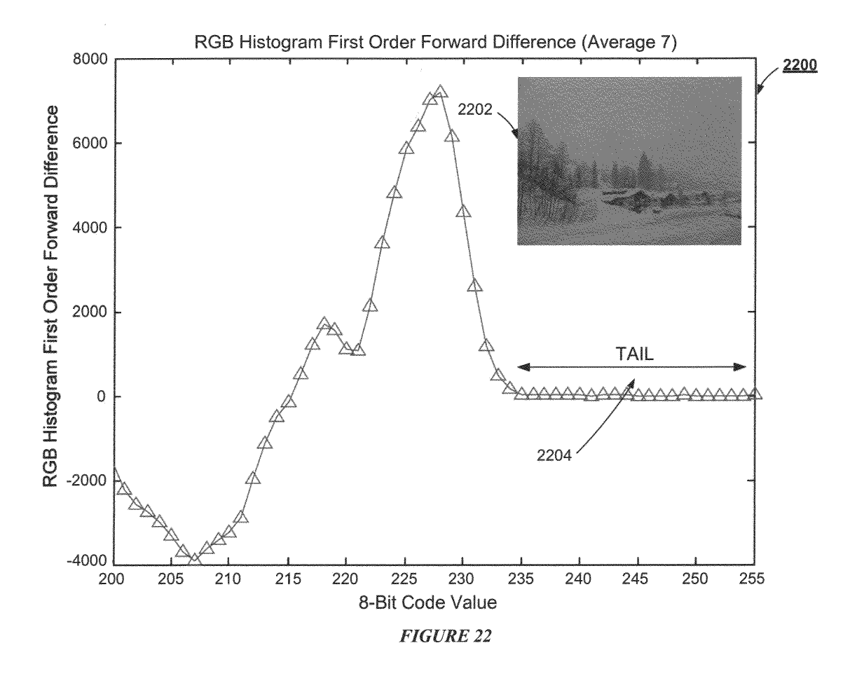

A further example of a false positive image 2202 is shown in the histogram 2200 of FIG. 22. As illustrated in FIG. 22, the histogram 2200 of the image 2202 contains a legitimate long tail 2204, but brightness adjustment was not applied in the ground truth because it is a tinted artistic scene, and brightness adjustment should not be applied to tinted artistic scenes. Suitable detection of artistic scenes in received image data is explained in U.S. patent application Ser. No. 12/039,225, entitled A SYSTEM AND METHOD FOR ARTISTIC IMAGE SCENE DETECTION, filed Feb. 28, 2008, the entirety of which is incorporated herein by reference. The skilled artisan will further appreciate that, in order to make all the parameters independent of the image sizes (number of pixels), the RGB histogram is normalized by the total number of pixels so that the histogram count is no longer the actual number of pixels but, rather, is the percentage or the ratio of the number of pixels over the total number of pixels.

In accordance with another example embodiment of the subject application, an input image is received, and an RGB histogram is calculated and normalized by the total number of pixels in the input image. Convolution in running average P is then applied so as to smooth the normalized histogram. The M-th order forward difference is then calculated and applied to the generated histogram. The tail start and tail length are then calculated with respect to the tail zone defined by the high threshold value HT and the low threshold value LT. A determination is then made as to whether the long tail starts sufficiently early, e.g., tail start<Th; the tail is of sufficient length, e.g., tail length>Th′; and the histogram count at tail start is sufficiently low, e.g., H[Tail Start]<Th″. When the tail start<Th, the tail length>Th′, and H[Tail Start]<Th ″, then the input image is determined to have a long tail. A determination is then made as to whether the input image is a fog scene, partial fog scene, or tinted artistic scene. If so, then no brightness adjustment is made to the input image. If the input image is not a fog scene, a partial fog scene, or a tinted artistic scene, the amount of brightness adjustment, e.g., white stretch (Delta), is calculated, where Delta=function of Tail Length; calculate Max=255−Delta; apply a tone Reproduction Curve (TRC), which maps (0, Max) to (0, 255), to all pixels in the input image. In accordance with an alternate embodiment, the same TRC is capable of being applied so as to build a Look Up Table (LUT) and then to apply the LUT to all pixels in the input image. Suitable example parameters associated with the preceding example are optimized as follows: P=7, i.e., convolution in running average of 7; M=1, i.e., first order forward difference; HT=2.3E-5, LT=1.6825E-5 for Tail Zone; and Th=4, Th′=8, and Th″=1.5E-4.

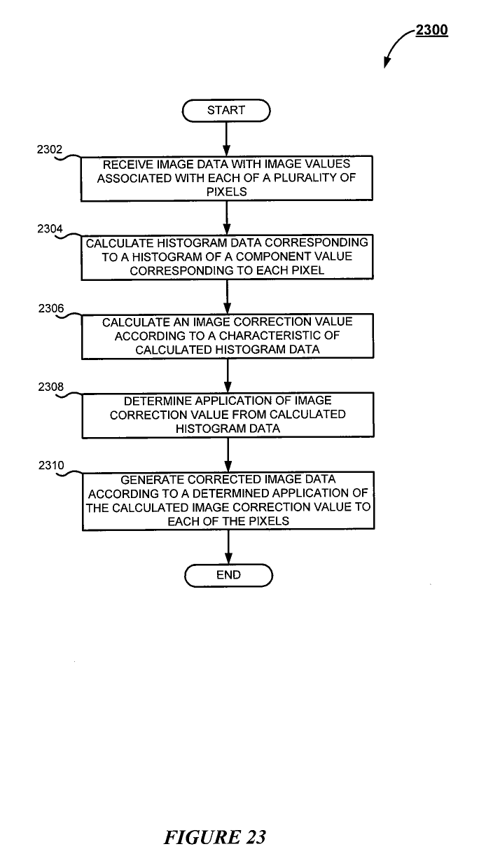

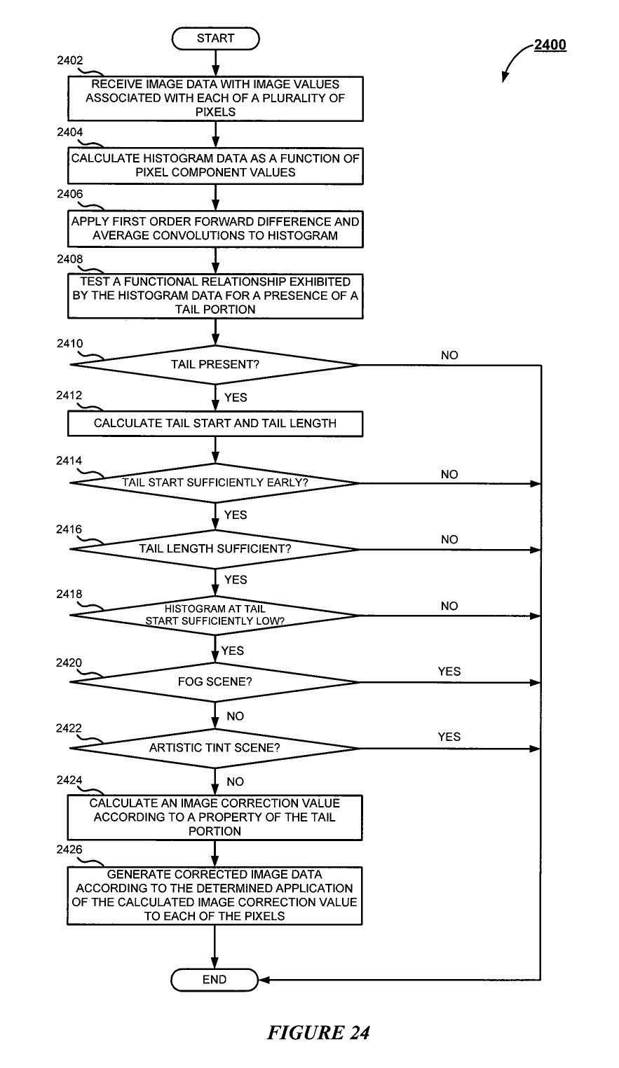

The skilled artisan will appreciate that the subject system 100 and components described above with respect to FIGS. 1-22 will be better understood in conjunction with the methodologies described hereinafter with respect to FIG. 23 and FIG. 24. Turning now to FIG. 23, there is shown a flowchart 2300 illustrating a method for brightness adjustment of electronic images in accordance with one embodiment of the subject application. Beginning at step 2302, image data is first received inclusive of an image value associated with each of a plurality of pixels. Histogram data is then calculated at step 2304 corresponding to a histogram of at least one component value corresponding to each pixel. Calculation of an image correction value then occurs at step 2306 in accordance with at least one characteristic of the calculated histogram data. Flow the proceeds to step 2308, whereupon the application of the calculated image correction value to the received input image is determined based upon an analysis of the received image data, e.g. the histogram data, fog scene detection, artistic scene detection, and the like. Thereafter, at step 2310, corrected image data is generated according to the determined application of the calculated image correction value to each of the plurality of pixels.

Referring now to FIG. 24, there is shown a flowchart 2400 illustrating a method for brightness adjustment of electronic images in accordance with one embodiment of the subject application. The methodology depicted in FIG. 24 begins at step 2402, whereupon an electronic image is received by the controller 108 or other suitable component associated with the document processing device 104, the user device 114, or the like. According to one embodiment of the subject application, the received image data includes image values associated with each of the plurality of pixels comprising the image. As will be appreciated by those skilled in the art, each image value is defined within a selected image space, wherein each pixel is comprised of at least one component value. In accordance with one embodiment of the subject application, the image space corresponds to a multidimensional space, with the result that each pixel has a plurality of component values. For example, when the multidimensional space corresponds to Red-Green-Blue (RGB) image space, each of the plurality of pixels of the received image data has a red component value, a green component value, and a blue component value.

At step 2404, histogram data is generated from the received image data as a function of the pixel values via the controller 108 or other suitable component associated with the document processing device 104, the user device 114, or other such component capable of processing electronic images. Suitable examples of histograms calculated in accordance with received image data are discussed in greater detail above with respect to FIGS. 4A through 22. In accordance with one embodiment of the subject application, the histogram, such as an RGB histogram, is calculated by the controller 108, the user device 114, or the like and is normalized by the total number of pixels, as explained in greater detail above. A first order forward difference and average convolutions are then applied to the histogram data at step 2406. As set forth above with respect to the examples discussed corresponding to FIGS. 4A through 22, convolution is, for example and without limitation, applied in a running average of P to smooth the normalized histogram and then to calculate its M-th order forward difference, e.g., P=7 and M=1, as evidenced in the FIGS. 4A through 22 discussed above.

At step 2408, the presence of a tail portion of the histogram data is then tested via a functional relationship exhibited by the histogram. The detection and appearance of a tail portion is discussed above with respect to FIGS. 4A through 22. A determination is then made at step 2410 as to whether a tail portion is present in the histogram data in accordance with the results of the test at step 2408. Upon a determination at step 2410 that no tail portion in the histogram data is detected by the controller 108 or other suitable component associated with the document processing device 104, the user device 114, or the like, the methodology of FIG. 24 terminates with no image correction, e.g., global brightness enhancement, white stretch, or the like, being undertaken in accordance with the subject application.

When it is determined at step 2410 that a tail portion is present in the histogram data, as determined by the testing of step 2408, flow proceeds to step 2412, whereupon the tail start and tail length are calculated. The skilled artisan will appreciate that the controller 108 or other suitable component associated with the document processing device 104, the user device 114, or the like then determines the point at which the tail portion begins on the histogram data and the length that such tail portion runs, as referenced above with respect to the example embodiments of FIGS. 4A through 22.

A determination is then made at step 2414 by the controller 108 or other suitable component associated with the document processing device 104 as to whether the tail starts sufficiently early, i.e., whether the start point of the tail portion occurs sufficiently early on the histogram of the input image to prompt the application of brightness adjustment, image correction, white stretch, or the like in accordance with the subject application. Upon a determination at step 2414 that the tail does not begin sufficiently early, the operations of FIG. 24 terminate with no adjustments made to the image in accordance with the system and method of the subject application.

A positive determination at step 2414 prompts the controller 108 or other suitable component associated with the document processing device 104 or the user device 114 to determine, at step 2416, whether the length of the tail meets or exceeds a predetermined length. Upon a determination at step 2416 that the length of the tail does not meet the predetermined threshold length, the methodology of FIG. 24 terminates with no image adjustments, e.g., white stretch, brightness adjustment, image correction, or the like, being applied to the received image data. When it is determined at step 2416 that the length of the tail meets or exceeds the predetermined threshold length, flow proceeds to step 2418. At step 2418, a determination is made as to whether the histogram count at the beginning of the tail is at or below a predetermined level. Upon a negative determination at step 2418, operations in accordance with the subject application terminate, with no image adjustments being made to the received image data.

When it is determined at step 2418 that the count at the start of the tail portion is at or below the predetermined level, flow proceeds to step 2420, whereupon a determination is made as to whether the received image data corresponds to a fog scene or a partial fog scene. When the received image data represents a fog scene or a partial fog scene, brightness adjustment is not required and operations terminate. When the received image data is determined not to correspond to a fog scene or a partial fog scene, flow proceeds to step 2422. At step 2422, a determination is made as to whether the received image data corresponds to an artistically tinted scene. When the image data does correspond to an artistically tinted scene, no brightness adjustment is applied to the received image data, and operations with respect to FIG. 24 terminate.

Upon a determination that the received image data is not an artistically tinted scene at step 2422, flow progresses to step 2424. At step 2424, an image correction value is calculated in accordance with a property of the tail portion. Suitable examples of such calculation of an image correction value are discussed above with respect to FIGS. 4A through 22. Following the calculation of a suitable image correction value, flow proceeds to step 2426. At step 2426, the calculated image correction value is applied to each of the pixels of the received image data, thereby generating corrected image data.

The subject application extends to computer programs in the form of source code, object code, code intermediate sources and partially compiled object code, or in any other form suitable for use in the implementation of the subject application. Computer programs are suitably standalone applications, software components, scripts, or plug-ins to other applications. Computer programs embedding the subject application are advantageously embodied on a carrier, being any entity or device capable of carrying the computer program; for example, a storage medium such as ROM or RAM; optical recording media such as CD-ROM or magnetic recording media such as floppy discs; or any transmissible carrier such as an electrical or optical signal conveyed by electrical or optical cable, radio, or other means. Computer programs are suitably downloaded across the Internet from a server. Computer programs are also capable of being embedded in an integrated circuit. Any and all such embodiments containing code that will cause a computer to perform substantially the subject application principles as described will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A brightness adjustment system for electronic images comprising:
means adapted for receiving image data inclusive of an image value associated with each of a plurality of pixels;
calculating means adapted for calculating histogram data corresponding to a histogram of at least one component value corresponding to each of the plurality of pixels;
calculating means adapted for calculating an image correction value in accordance with at least one characteristic of the calculated histogram data;
means adapted for determining an application of the calculated image correction value from the calculated histogram data; and
correction means adapted for generating corrected image data in accordance with a determined application of the calculated image correction value to each of the plurality of pixels.

2. The system of claim 1, wherein each image value is defined within a selected image space such that each pixel is comprised of at least one component value, and wherein the system further includes means adapted for calculating the histogram data as a function of pixel component values.

3. The system of claim 2, wherein the image space is multidimensional such that each pixel is comprised of a plurality of component values.

4. The system of claim 3, wherein the image space is defined as an RGB image space, and wherein each pixel includes a red component value, a green component value, and a blue component value.

5. The system of claim 2, further comprising testing means adapted for testing a functional relationship exhibited by the histogram data for a presence of a tail portion, and wherein the calculating means includes means adapted for calculating the image correction value in accordance with a property of the tail portion.

6. The system of claim 5, wherein the calculating means includes means adapted for calculating the tail portion in accordance with a test against preselected threshold values.

7. The system of claim 6, wherein the property of the tail portion includes at least one of length and starting value thereof.

8. The system of claim 7, further comprising detection means adapted for detecting at least one of the group consisting of a fog scene and a tinted artistic scene.

9. The system of claim 8, wherein the determining means includes means for determining an application of the calculated image correction value in accordance with a detection of at least one of a fog scene and a tinted artistic scene.

10. A brightness adjustment method for electronic images comprising the steps of:
receiving image data inclusive of an image value associated with each of a plurality of pixels;
calculating histogram data corresponding to a histogram of at least one component value corresponding to each of the plurality of pixels;
calculating an image correction value in accordance with at least one characteristic of the calculated histogram data;
determining an application of the calculated image correction value from the calculated histogram data; and
generating corrected image data in accordance with a determined application of the calculated image correction value to each of the plurality of pixels.

11. The method of claim 10, wherein each image value is defined within a selected image space such that each pixel is comprised of at least one component value, and wherein the method further includes the step of calculating the histogram data as a function of pixel component values.

12. The method of claim 11, wherein the image space is multidimensional such that each pixel is comprised of a plurality of component values.

13. The method of claim 12, wherein the image space is defined as an RGB image space, and wherein each pixel includes a red component value, a green component value, and a blue component value.

14. The method of claim 11, further comprising the step of testing a functional relationship exhibited by the histogram data for a presence of a tail portion, and wherein the step of calculating the image correction value is in accordance with a property of the tail portion.

15. The method of claim 14, wherein the step of calculating the tail portion is in accordance with a test against preselected threshold values.

16. The method of claim 15, wherein the property of the tail portion includes at least one of length and starting value thereof.

17. The method of claim 16, further comprising the step of detecting at least one of the group consisting of a fog scene and a tinted artistic scene.

18. The method of claim 17, wherein the step of determining an application of the calculated image correction value is in accordance with a detection of at least one of a fog scene and a tinted artistic scene.
